(19) United States
(12) Patent Application Publication
(10) Pub. No.: US 2008/0016981 A1
(43) Pub. Date: Jan. 24, 2008

(54) Cycle Heat and Cool

(76) Inventor: James P. Flynn, Smithtown, NY (US)

Correspondence Address: ADVANTIA LAW GROUP, 9035 SOUTH 1300 EAST, SUITE 200, SANDY, UT, 84094, US

(21) Appl. No.: 11/306,140

(22) Filed: Dec. 16, 2005

(51) Int. Cl. B62K 21/12

(52) U.S. Cl. 74/551.8

(57) ABSTRACT

A climate control system for motorcycles. There is a control module coupled to the motorcycle and accessible to a user; a heating module coupled to an interface portion of the motorcycle and functionally coupled to the control module; and a cooling module coupled to an interface portion of the motorcycle and functionally coupled to the control module. The interface portion is selected from the group consisting of handles, seat, and foot rest. The control module is coupled to the handles and accessible therefrom. The heating module comprises a first heating mode and a second heating mode that is of a lower heat flow than the first heating mode wherein the control module automatically switches to the second heating mode after a programmed time elapses from actuation of the first heating mode. The system comprises a retrofit kit configured to be added to a motorcycle.

### BACKGROUND OF THE INVENTION

1. Field of the Invention

The present invention relates to climate control systems, specifically to climate control systems for motorcycles.

2. Description of the Related Art

In U.S. Pat. No. 4,555,911 to Kusisto, there is disclosed a air conditioner system for bicycles and other vehicles, the system using a wheel of the vehicle as a source of power, air flow through an ice chamber being useable in the system as an optional further coolant.

Also, in U.S. Pat. No. 4,471,209 to Hollander, there is disclosed electrically heated hand grips for the handle bars of vehicles such as motorcycles and the like that are fabricated with an inner cylindrical sleeve member molded of synthetic plastic material. An electrical resistance heater wire coil is embedded in each sleeve. The inner surface of said the sleeve includes a plurality of circumferentially spaced and axially extending ribs, and the outer surface of said the sleeve includes a longitudinally extending land and groove pattern. The spaces between the ribs on the inner surface and the grooves on the outer surface of the sleeve have radially coextensive, overlapping circumferential portions where the sleeve is of minimum wall thickness. The resistance wire coil is disposed within said the sleeve member such that it is spaced a substantial distance from the inner surface of the ribs and the outer surface of the lands. The diameter of the heater wire is not less than the minimum wall thickness of the sleeve. The heated hand grip also includes an outer sheath of resilient material which is molded onto and encapsulates the inner sleeve. Electrical lead wires are connected to the ends of said electrical resistance wires.

Further, in US Patent Application No. 2004/0011777 to Richlen, there is disclosed a heated motorcycle handgrip securable to a motorcycle handlebar and including a grip housing that has a first end adapted to receive the handlebar, and a second end opposite the first end. The grip housing includes a heating element that is operable to provide a heat output, and a heater control dial is coupled to the second end of the handgrip to control the heat output of the heating element.

The entire contents of the above listed references are incorporated by reference herein.

What is needed is a climate control system that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available climate control systems. Accordingly, the present invention has been developed to provide a climate control system for motorcycles.

In one embodiment, there is a climate control system for motorcycles. There may be a control module coupled to the motorcycle and accessible to a user; a heating module coupled to an interface portion of the motorcycle and functionally coupled to the control module; and/or a cooling module coupled to an interface portion of the motorcycle and functionally coupled to the control module. The interface portion may be selected from the group consisting of handles, seat, and foot rest. The control module may be coupled to the handles and accessible therefrom. The heating module may include a first heating mode and/or a second heating mode that may be of a lower heat flow than the first heating mode wherein the control module may automatically switch to the second heating mode after a programmed time elapses from actuation of the first heating mode. The system may include a retrofit kit configured to be added to a motorcycle.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a side view of a motorcycle including a climate control system according to one embodiment of the invention; and

FIG. 2 is a block diagram showing a climate control system according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Turning to the figures, there is illustrated a climate control system 100 for motorcycles according to one embodiment of the invention. There is illustrated a control module 110 coupled to the motorcycle 99 and accessible to a user. There is also shown a heating module 120 coupled to an interface portion, or interface module 104 of the motorcycle 99 and functionally coupled to the control module 110. Further, in the illustrated embodiment, there is a cooling module 130 coupled to an interface portion 104 of the motorcycle 99 and functionally coupled to the control module 110. The illustrated interface portions 104 are handles 106, seat 104, and foot rest 104. The illustrated control module 110 is coupled to the handles 104 and accessible therefrom. An interface portion 104 may be any portion of a motorcycle 99 to which a user may desire to come in substantial contact while using the motorcycle 99. As used in this application, the term motorcycle 99 includes other open vehicles such as but not limited to ATV and snowmobiles.

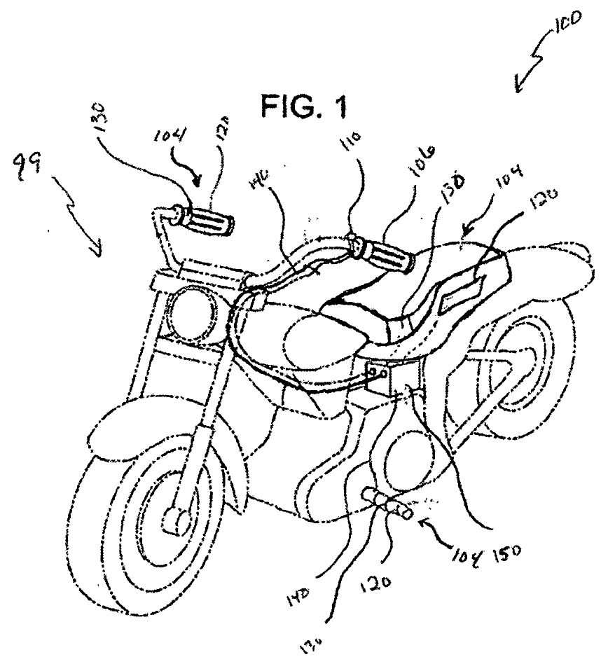

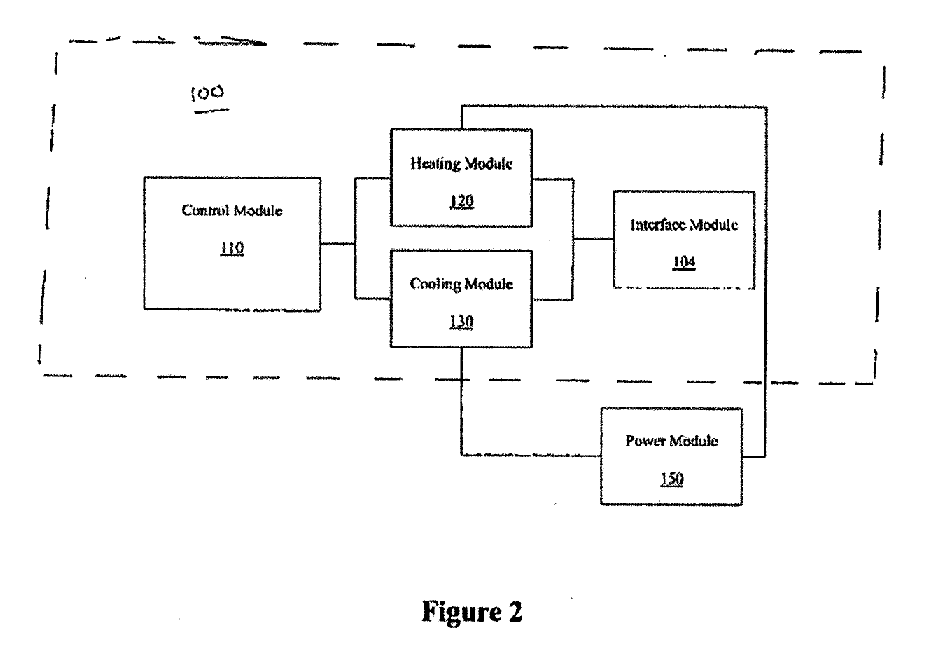

In one embodiment, the heating module 120 comprises a first heating mode and a second heating mode that is of a lower heat flow than the first heating mode wherein the control module 110 automatically switches to the second heating mode after a programmed time elapses from actuation of the first heating mode. In another embodiment, the system 100 comprises a retrofit kit configured to be added to a motorcycle 99. In one embodiment, as shown in FIG. 1, the control module 110 may couple to and direct the power module 150 through wires 140 which then may activate and/or direct activation of the heating and/or cooling modules 120 and/or 130 through wires 140. In another example, the modules 110, 120, 130, and 150 may be functionally coupled as shown in FIG. 2. It is envisioned that there are a multiplicity of modes of connecting and controlling modules of the system 100, and such are within the scope of the invention.

In yet another embodiment, the control module 110 may include physical and/or electric controls configured to actuate, activate, switch, and/or adjust functioning of the heating and/or cooling modules. Embodiments include buttons, switches, connections, and twist selectors. In one example, a control module 110 sends an electrical signal to a heating and/or cooling module in response to actuation by a user. It is appreciated that such devices are commonly known in the art and varieties of such are plethoric. The heating module 120 may include one or more heat transducers, such as but not limited to: heat producing electrical components, heat conducting materials selectably coupleable to a hot item, heat pumps, and/or heated fluid circulators. The cooling module 130 may include one or more cold transducers, such as but not limited to: heat removing electrical components, heat conducting materials selectably coupleable to a cold item, heat pumps, and/or cooled fluid circulators.

In one embodiment, there is a series of heating elements incorporated into a motorcycle's 99 handle grips 106, seat, and foot rests. There is a two-position switch in the vicinity of either handlebar and wired to the heating elements, drawing power from a power element, such as drawing electrical power from an alternator coupled to a motor of the motorcycle. The switch includes a symbol for heat and a symbol for cool. When activated in heat mode, the heating elements are activated in a “high” mode and warm the interface portions. After a predetermined interval, the system changes from the “high” mode to the “low” mode via timing circuit, with the purpose of maintaining a desired temperature range. After another period of time, the heating element may automatically turn off.

In a cool mode, selected through the control module 110, one or more interface portions 104 are cooled by an evaporator, which transports cool air from an air-cooled condenser with a compressor driven by the engine of the motorcycle 99. The cool mode may or may not include a multi-stage mode similar to that of the heat mode.

In one example, the system 100 is incorporated into a design of a newly manufactured motorcycle 99. In one example, the system is an aftermarket accessory, a retro-fit kit, configured to be installed in an existing motorcycle 99.

In operation, a user may use a motorcycle 99 and may be riding and/or coupled to the motorcycle 99 at one or more interface portions 104. The user may then select and control temperature flow through one or more interface portions 104. The user may initiate a sequence of heating and/or cooling steps whereby the user may experience a series of heating and/or cooling steps configured to enhance the comfort of the user without requiring the user to individually initiate each step.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A climate control system for motorcycles, comprising:
a control module coupled to the motorcycle and accessible to a user;
a heating module coupled to an interface portion of the motorcycle and functionally coupled to the control module; and
a cooling module coupled to an interface portion of the motorcycle and functionally coupled to the control module.

2. The climate control system of claim 1, wherein the interface portion is selected from the group consisting of handles, seat, and foot rest.

3. The climate control system of claim 2, wherein the control module is coupled to the handles and accessible therefrom.

4. The climate control system of claim 3, wherein the heating module comprises a first heating mode and a second heating mode that is of a lower heat flow than the first heating mode wherein the control module automatically switches to the second heating mode after a programmed time elapses from actuation of the first heating mode.

5. The climate control system of claim 4, wherein the system comprises a retrofit kit configured to be added to a motorcycle.

6. A climate control system for motorcycles, consisting essentially of:
a control module coupled to the motorcycle and accessible to a user;
a heating module coupled to an interface portion of the motorcycle and functionally coupled to the control module; and
a cooling module coupled to an interface portion of the motorcycle and functionally coupled to the control module.

7. The climate control system of claim 6, wherein the interface portion is selected from the group consisting of handles, seat, and foot rest.

8. The climate control system of claim 7, wherein the control module is coupled to the handles and accessible therefrom.

9. The climate control system of claim 8, wherein the heating module comprises a first heating mode and a second heating mode that is of a lower heat flow than the first heating mode wherein the control module automatically switches to the second heating mode after a programmed time elapses from actuation of the first heating mode.

10. The climate control system of claim 9, wherein the system comprises a retrofit kit configured to be added to a motorcycle.
